(19) United States
(12) Patent Application Publication
(10) Pub. No.: US 2008/0276281 A1
(43) Pub. Date: Nov. 6, 2008

(54) Information Processing Device, Information Processing Method, Information Processing Program, and Recording Medium Recorded with the Information Processing Program

(75) Inventors: Masakazu Ogawa, Saitama (JP); Katsuhito Fujikura, Saitama (JP)

Correspondence Address: KRATZ, QUINTOS & HANSON, LLP, 1420 K Street, N.W., Suite 400, WASHINGTON, DC, 20005, US

(73) Assignee: PIONEER CORPORATION, Tokyo (JP)

(21) Appl. No.: 11/795,206

(22) PCT Filed: Dec. 26, 2005
(86) PCT No.: PCT/JP05/23713

§ 371 Date: Mar. 6, 2008

(30) Foreign Application Priority Data
Jan. 13, 2005 (JP) 2005-006530

(51) Int. Cl. H04N 5/445

(52) U.S. Cl. 725/50

(57) ABSTRACT

A recording/reproducing system (100) displays timer-recording information recorded in timer-recording list information in a display area as a timer-recording list. Further, upon recognizing that at least one of the timer-recording information is selected among the displayed timer-recording information, the recording/reproducing system (100) carries out control so as to display basic program information corresponding to the selected timer-recording information on a program list based on program information table. Accordingly, a user can easily check presence of timer-recording information that overlaps a program which has been set for timer-recording, or check programs that are broadcast before and after the program that has been set for timer-recording.

### TECHNICAL FIELD

The present invention relates to an information processing device, an information processing method, an information processing program, and a recording medium recorded with the information processing program, for processing information.

### BACKGROUND ART

Conventionally, there has been known a structure for acquiring an electric program guide (EPG) distributed from broadcast stations and the like, and recording desired broadcast programs based on the EPG (see, for example, Patent Document 1).

A technique disclosed in Patent Document 1 employs a structure in which operation statuses of an input device of a user are successively monitored by a profile extractor, and a user profile which is a group of pieces of data directly or indirectly representing preferences of the user is generated based on the monitored operation statuses. Further, candidate programs that are judged that the user may wish to view are selected from programs indicated by program list information output from a program list management device based on the generated user profile, to generate a speculation recording candidate program list. After that, a speculation recording management device supports a storage management device to record a speculation recording target program based on the speculation recording candidate program list output from a speculation selector.

[Patent Document 1] JP 2004-48718 A (see pages 10 to 14 and FIGS. 2 to 4)

### DISCLOSURE OF THE INVENTION

### Problems to be Solved by the Invention

Incidentally, the speculation recording candidate program list used in the conventional structure as disclosed in Patent Document 1 is information regarding programs judged to be strongly preferred by users. Thus, it is impossible to check broadcast statuses of programs that are broadcast on other channels substantially at the same time as a broadcast time at which a program registered in the speculation recording candidate program list is broadcast, or programs that are broadcast before and after the registered program. Therefore, the user needs to additionally check information regarding broadcast schedules of the programs for checking the broadcast statuses as described above, resulting in complexity, for example.

It is an object of the present invention to provide an information processing device, an information processing method, an information processing program, and a recording medium recorded with the information processing program, for facilitating checking of statuses of information.

### Means for Solving the Problems

According to the present invention, there is provided an information processing device, including: a distribution information acquisition unit for acquiring distribution information regarding distribution of contents; a producing unit for producing a contents distribution list based on the distribution information; a timer-recording controller for timer-recording the contents; a first display controller for controlling a display unit to display timer-recording information regarding timer-recording of the contents; a selection unit for selecting at least one of the timer-recording information; and a second display controller for controlling the display unit to display the contents distribution list containing information on contents corresponding to the selected timer-recording information.

Further, according to the present invention, there is provided an information processing method, including: acquiring distribution information regarding distribution of contents; producing a contents distribution list based on the distribution information; timer-recording the contents; controlling a display unit to display timer-recording information regarding timer-recording of the contents; selecting the timer-recording information; and controlling the display unit to display the contents distribution list containing the contents corresponding to the selected timer-recording information.

Further, according to the present invention, there is provided an information processing program, which causes a computing unit to function as the information processing device described above.

Further, according to the present invention, there is provided an information processing program, which causes a computing unit to carry out the information processing method described above.

Further, according to the present invention, there is provided a recording medium recorded with an information processing program, which has the processing program described above readably recorded thereon by a computing unit.

### BRIEF DESCRIPTION OF DRAWINGS

FIG. 1 is a block diagram showing a schematic structure of a contents recording/reproducing system according to an embodiment of the present invention.

FIG. 2 is a schematic diagram showing a schematic structure of a program information table stored in an EPG storage area.

FIG. 3 is a schematic diagram showing a schematic structure of timer-recording list information.

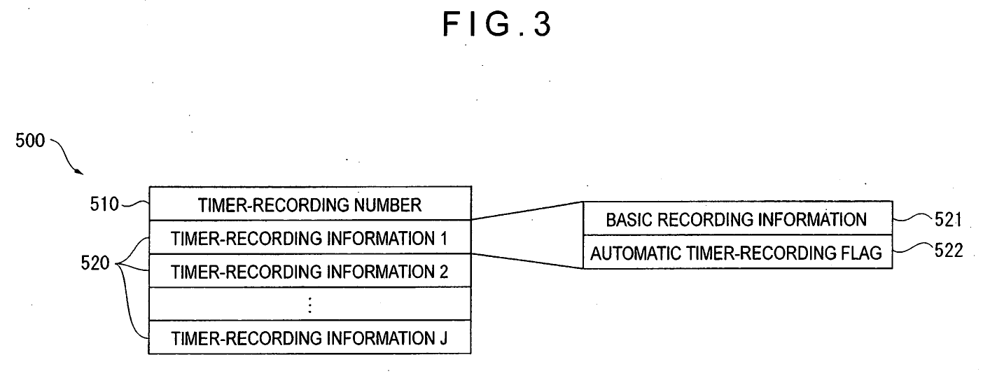

FIG. 4 is a schematic diagram showing a schematic structure of a CPU constituting a recorder/reproducer.

FIG. 5 is a schematic diagram showing an example of a timer-recording list.

FIG. 6 is a schematic diagram showing an example of a program list display screen.

FIG. 7 is a flowchart regarding screen switching processing between the timer-recording list and the program list.

### EXPLANATION OF CODES

200: recorder/reproducer as information processing device
210: communication unit as distribution information acquisition unit
290: CPU which also functions as computing unit
291: request information recognizer which also functions as selection unit and distribution information selection unit
294: which also functions as determination unit
295: display controller which also functions as first display controller and second display controller
296: program timer-recording unit as timer-recording controller
321: display area as display
400: program information table as contents distribution list
430: basic program information as distribution information
520: timer-recording information

### BEST MODE FOR CARRYING OUT THE INVENTION

Hereinafter, an embodiment of the present invention will be described based on the drawings. In this embodiment, a recorder/reproducer equipped with an information processing device of the present invention will be exemplified. However, the present invention is not limited thereto and is also applicable as a recorder for merely recording information, an independent information processing device for causing the recorder or the recorder/reproducer to record information, an information processing device for controlling reception of information with, for example, a receiver such as a television which does not employ a structure for recording, and the like. In addition, in this embodiment, a description will be given of acquisition processing based on, for example, an electric program guide (EPG) as distribution information which is information on contents distribution regarding broadcast programs. However, the present invention is not limited thereto and various programs such as radio broadcast programs, satellite broadcast programs, contents of music and videos to be distributed, and game software can be set as targets for information distribution, and any structure for acquiring information based on contents information regarding contents of each piece of information can be applied. Further, recording processing corresponding to information acquisition is appropriately referred to as contents recording processing, and information processing is appropriately referred to as contents reproducing processing.

(Structure of Contents Recording/Reproducing System)

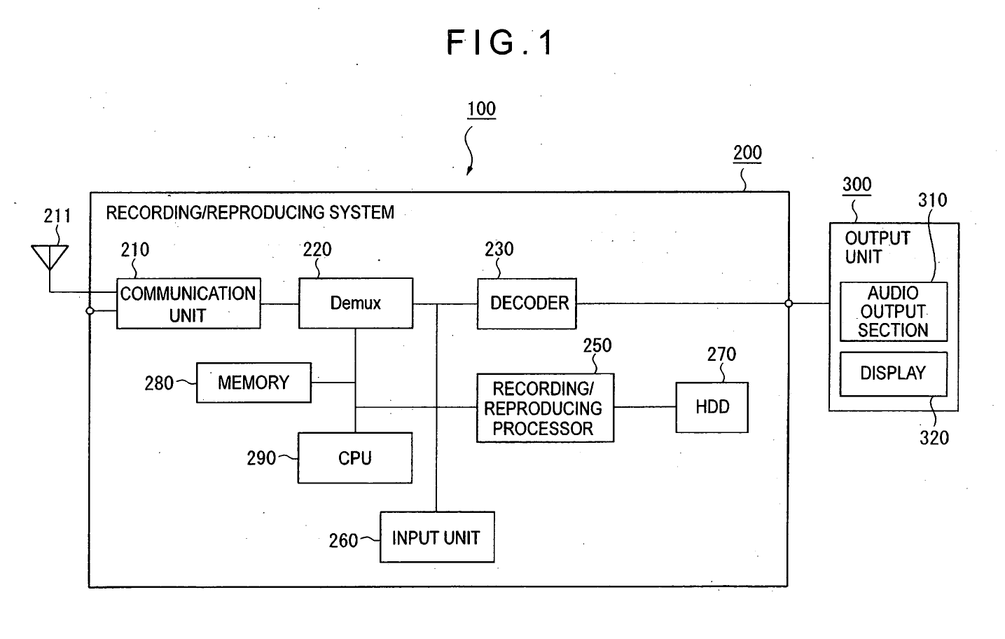

In FIG. 1, reference numeral 100 denotes a contents recording/reproducing system (hereinafter, referred to as recording/reproducing system) which is a system for recording contents information including information containing audio information, video information, and information of data information of contents such as television (TV) programs, and reproducing the recorded contents information. Further, the recording/reproducing system 100 includes a recorder/reproducer 200 as the information processing device and an output unit 300.

Examples of the output unit 300 include a personal computer, a television, a cellular phone, a personal handyphone system (PHS), and a personal digital assistants (PDA). The output unit 300 receives and outputs contents information output from the recorder/reproducer 200. Further, the output unit 300 includes an audio output section 310 and a display 320.

The audio output section 310 includes, for example, an audio producing unit such as a speaker (not shown). The audio output section 310 carries out processing of outputting audio information transmitted as analog signals from the recorder/reproducer 200 as audio from the audio producing unit. Note that the audio producing unit can also output TV audio information and the like received by a TV receiver (not shown) as appropriate, for example.

The display 320 displays video information, broadcast information, EPG information, synthesis information, setting information, and the like transmitted as analog signals from the recorder/reproducer 200. The video information to be displayed in this case is, for example, contents videos. Further, examples of the broadcast information include subtitles and data broadcast of contents. Further, an example of the EPG information includes a program list which is the electric program guide containing a program name, contents, broadcast start time and date, and the like of the contents which are broadcast on respective channels. Still further, examples of the synthesis information include a synthesis video obtained by superimposing subtitles on the contents video and a video obtained by arranging the data broadcast and the program list. Yet further, examples of the setting information include a genre selection video for prompting selection of a genre of the broadcast programs and a list of broadcast programs processed in the recorder/reproducer 200. Examples of the display 320 include a liquid crystal display panel, an organic EL (Electro Luminescence) panel, a PDP (Plasma Display Panel), a CRT (Cathode-Ray Tube), a FED (Field Emission Display), and an electrophoresis display panel. Note that the display 320 can also output TV video information and the like received by the TV receiver as appropriate, for example.

The recorder/reproducer 200 carries out processing of acquiring and recording the contents information containing the audio information, the video information, the information broadcast information, and the like distributed as a TS (transport stream), and causing the output unit 300 to output the contents information. In addition, the recorder/reproducer 200 carries out processing of appropriately reproducing the recorded contents information and causing the output unit 300 to output the reproduced contents information. Further, the recorder/reproducer 200 appropriately and automatically deletes the recorded contents information. The recorder/reproducer 200 includes a communication unit 210 as a distribution information acquisition unit, a demultiplexer (Demux) 220, a decoder 230 that functions as a contents distribution list producing unit, a recording/reproducing processor 250, an input unit 260, a HDD (Hard Disk Drive) 270 and a memory 280 as storage units, and a CPU (Central Processing Unit) 290 as a computing unit.

The communication unit 210 acquires various types of information such as contents information input from an external device, and outputs the acquired various types of information such as the contents information to the external device as appropriate. In addition, the communication unit 210 is connected to an antenna 211 through which broadcast waves of, for example, a ground wave digital broadcast or a satellite digital broadcast are received, and acquires information transmitted as analog signals or digital signals through the antenna 211, for example, a TS corresponding to the contents selected by the user from a plurality of TSs. Then, the communication unit 210 outputs the acquired TS to the Demux 220. Further, the communication unit 210 includes an interface of, for example, an IEEE (Institute of Electrical and Electronics Engineers) 1394 standard capable of carrying out high-speed information processing, and acquires a TS or partial TS to be described later which is transmitted as digital signals from the external device (not shown) provided outside the recorder/reproducer 200 so as to output the acquired TS or the partial TS to the Demux 220. Further, the communication unit 210 acquires the partial TS output from the recording/reproducing processor 250, and appropriately processes and transmits the acquired partial TS as digital signals, to the external device (not shown) provided outside the recorder/reproducer 200.

The Demux 220 is connected with the decoder 230, the recording/reproducing processor 250, the CPU 290, and the like, and acquires a TS from the communication unit 210, appropriately separates TS packets from the acquired TS, and outputs the TS packets. Specifically, the Demux 220 acquires, based on control by the CPU 290, a TS packet into which audio information is incorporated (hereinafter, referred to as audio packet), a TS packet into which video information is incorporated (hereinafter, referred to as video packet), and a TS packet into which EPG information or the like as the information broadcast information or the distribution information is incorporated (hereinafter, referred to as information packet). Then, the Demux 220 outputs the acquired audio packet, video packet, and information packet to the decoder 230. In addition, under the control of the CPU 290, the Demux 220 restructures the TS packets into a TS having a serial information string structure, that is, the partial TS, upon acquiring the TS packets corresponding to the contents which have been selected from the acquired TS, to thereby output the partial TS to the recording/reproducing processor 250. After that, under the control of the CPU 290, upon acquiring the partial TS from the communication unit 210 or the recording/reproducing processor 250 as appropriate, the Demux 220 separates the partial TS into the audio packet, the video packet, and the information packet and outputs the packets to the decoder 230.

The EPG information in this case is information containing the information regarding the contents of the broadcast programs and the like of each of the TSs that can be acquired by the communication unit 210 in a text format such as a BML (Broadcast Markup Language) or an XML (Extensible Markup Language). Specifically, the EPG information, details of which will be described later, contains information such as a program description regarding a program name, program contents, and the like, a broadcast start time and date, a length of a program broadcast time, a channel number, a genre, and a series name as one information structure.

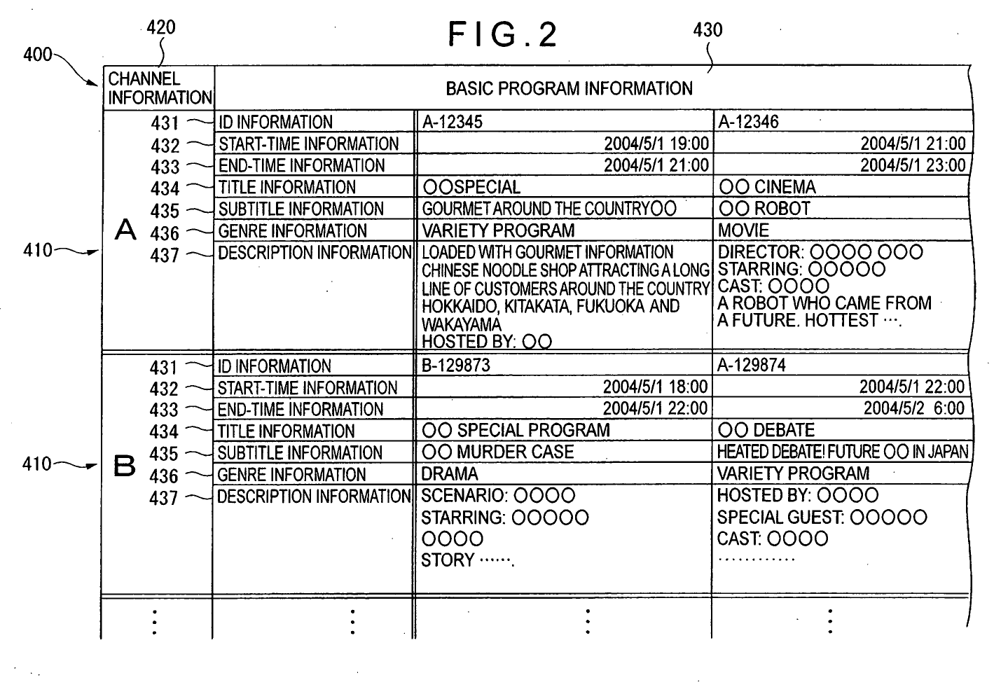

The decoder 230 is connected to the Demux 220, the CPU 290, the output unit 300, and the like, and appropriately demodulates the packets acquired from the Demux 220 and appropriately outputs the demodulated packets to the output unit 300. Specifically, under the control of the CPU 290, the decoder 230 acquires the audio packet from the Demux 220, demodulates the audio information incorporated in the acquired audio packet, and transmits the demodulated audio information to the audio output section 310 of the output unit 300 as analog signals. Alternatively, the decoder 230 acquires the video packet from the Demux 220, demodulates the video information incorporated in the acquired video packet, and outputs the demodulated video information to the output unit 300. Alternatively, the decoder 230 acquires the information packet from the Demux 220, demodulates the information broadcast information, EPG information, or the like incorporated in the information packet, and outputs the demodulated information to the output unit 300. Further, in a case where the EPG information is incorporated in the information packet, the decoder 230 produces, under the control of the CPU 290, a program information table 400 as shown in FIG. 2 based on the EPG information, and appropriately outputs the program information table 400 to the HDD 270.

The recording/reproducing processor 250 is connected to the HDD 270, the CPU 290, and the like. In addition, the recording/reproducing processor 250 appropriately acquires the partial TS from the Demux 220 and stores the acquired partial TS in the HDD 270, or appropriately acquires the partial TS stored in the HDD 270 to output the partial TS to the communication unit 210 or the Demux 220.

The input unit 260 is connected to the CPU 290 and the like. The input unit 260 includes, for example, various operation buttons or operation tabs (which are not shown) provided so as to enable to perform an input operation while facing, for example, a front surface of a case body (not shown). The input operation is performed by using the operation buttons or the operation tabs to set the setting of operation contents of the recorder/reproducer 200, for example. Specific examples of the setting of operation contents include a setting regarding a genre selection for retrieving a desired broadcast program, a setting regarding recording and reproduction of the contents, and a setting of a TS to be received by the communication unit 210. Further, the input unit 260 also functions as a unit for producing request information to be described later which requests execution of retrieval, recording, or reproduction of the broadcast program according to the input operation. Further, through the input operation of the setting items, the input unit 260 transmits various types of information as operation signals to the CPU 290 so that the various types of information are set. The input unit 260 in this case may employ, for example, a structure including a remote controller light receiving unit for receiving various types of information transmitted from a remote controller (not shown) through infrared light, and transmitting the received various types of information to the CPU 290 as operation signals.

The HDD 270 is connected to the CPU 290 and the like. The HDD 270 is controlled by an ATA (AT attachment) interface, for example. Note that here, a structure in which the HDD 270 is controlled by the ATA interface is exemplified. However, the HDD 270 may be controlled by an IDE (Integrated Drive Electronics) interface, a SCSI (Small Computer System Interface) interface, or the like. Further, there may be employed a structure including a drive or a driver for readably storing various types of information in various recording media, for example, an optical disc such as a DVD (Digital Versatile Disc), a magneto-optical disc, a removable memory such as a memory card, and a fixed memory instead of the HDD 270. The HDD 270 readably stores the partial TS of the contents input from the recording/reproducing processor 250, that is, contents information, EPG information, or the like, as appropriate. Specifically, the HDD 270 includes an information storage area (not shown) for storing contents information, an EPG storage area for storing the EPG information as the program information table 400 serving as the data distribution information as shown in FIG. 2, and a timer-recording list storage area for storing timer-recording list information 500 regarding a program to be timer-recorded. Note that the information storage area, the EPG storage area, the timer-recording list storage area, and the like may be stored and constructed in the memory 280.

The program information table 400 is produced in the decoder 230 based on the EPG information and is output to the HDD 270. Here, the EPG contained in the broadcast wave transmitted from the respective broadcast stations is program information mainly containing information regarding TV broadcast programs scheduled to be broadcast at the respective broadcast stations. In addition, contents information of the TV broadcast programs whose various types of information are shown in the program information table 400 functions as predetermined information of the present invention. The program information table 400 is stored in the EPG storage area as a table structure obtained by combining EPGs of the respective broadcast stations as described above. In addition, the EPG storage area for storing the program information table 400 has a table structure for recording a plurality of pieces of program information 410 structured as one information structure in which channel information 420 regarding a broadcast channel of the TV broadcast program, basic program information 430 as the distribution information, and the like are associated with one another, for example. Note that the program information table 400 may employ a structure in which the plurality of pieces of program information 410 are recorded in a form of a list. Thus, the program information table 400 is not particularly limited in its recording structure with which the information is recorded.

The channel information 420 is information regarding a channel on which the TV broadcast program is broadcast. The channel information 420 is individually set according to an area where the TV broadcast program is broadcast.

The basic program information 430 is recorded with broadcast times of TV broadcast programs, detailed information on program contents, and the like. In addition, the basic program information 430 contains, for example, ID information 431, start-time information 432 as characteristics information, end-time information 433 as distribution time information serving as characteristics information, title information 434 as contents information, subtitle information 435, genre information 436 as contents information, and description information 437, which are structured as one information structure. The various types of information contained in the basic program information 430 are described in a simple structure such as a text format, that is, in character strings.

The ID information 431 is unique identification information assigned to each piece of basic program information 430, for identifying the TV broadcast program. The ID information 431 is, for example, a unique identification value or an identification code that has been arbitrarily allocated, which is used for identifying the TV broadcast program at the time of programming timer-recording for the TV broadcast program.

The start-time information 432 is information regarding a scheduled time at which the broadcast of the TV broadcast program starts. The start-time information 432 contains a date and time at which the TV broadcast program is to be broadcast. The start-time information 432 is referred to at the time of starting recording of the broadcast program.

The end-time information 433 is information regarding a scheduled time at which the broadcast of the TV broadcast program ends. The end-time information 433 contains a date and time at which the broadcast of the TV broadcast program ends. The end-time information 433 is referred to in processing of ending the recording of the broadcast program.

The title information 434 is information regarding names such as a program name or title name of the TV broadcast program. The subtitle information 435 is information regarding names such as a subtitle name of the TV broadcast program.

The genre information 436 is information describing to which genre the TV broadcast program belongs in a case where the TV broadcast programs are classified into genres (types) in terms of contents. Examples of each of the genres include a “variety program (show)”, “drama”, “movie”, “news report”, “news”, and “sports”. Further, with respect to the “variety program”, for example, the genre information 436 may be associated with further-classified information as a sub-classification such as “popular songs” and “entertainment”.

The description information 437 is information containing a description simply explaining the broadcast contents of the TV broadcast program, or detailed contents of the TV broadcast program such as a story or names of individuals such as a cast, a director, and a playwright in a text format.

The timer-recording list information 500 is information regarding a list of manual timer-recordings or automatic timer-recordings. The timer-recording list information 500 has a structure in which the distribution contents information, a timer-recording number 510 as recording schedule information, at least one piece of timer-recording information 520, and the like are associated with one another as one data structure. Here, the manual timer-recording refers to a timer-recording set by designating information necessary for recording, such as a start-time or end-time, and a broadcast channel of the program. In addition, the automatic timer-recording refers to a timer-recording set by selecting a program from the electric program guide (EPG), that is, a timer-recording set through automatic setting of the information necessary for recording as described above. Note that as another example of the automatic timer-recording, there is a system involving setting in advance a specific keyword based on a preference of a user (e.g., name of a preferred actor) and automatically retrieving a program related to the keyword from the electronic program guide, thereby automatically setting timer-recording. As another timer-recording method, there is a G-code input and the like. However, the other various recording setting methods may be arbitrarily set as the manual timer-recording or the automatic timer-recording.

The timer-recording number 510 is information regarding a total number of pieces of timer-recording information 520. The timer-recording number 510 is incremented by 1 as a result of the additional setting of the manual timer-recording or the automatic timer-recording by the CPU 290, and is decremented by 1 when the recording based on the manual timer-recording or the automatic timer-recording is ended.

The timer-recording information 520 is information regarding the manual timer-recording or the automatic timer-recording. The timer-recording information 520 is incorporated by the CPU 290 in the timer-recording list information 500 when the manual timer-recording or the automatic timer-recording is set, and is deleted from the timer-recording list information 500 when the recording based on the manual timer-recording or the automatic timer-recording is ended. In addition, the timer-recording information 520 has a structure in which basic recording information 521 and an automatic timer-recording flag 522 are associated with each other as one data structure.

The basic recording information 521 is various types of information necessary for carrying out manual timer-recording processing or automatic timer-recording processing. Specifically, the basic recording information 521 has a structure in which a recording start time and date as distribution time and date information, a recording end time and date as the distribution time and date information, a channel number as frequency information, and the like are associated with one another as one data structure. Further, the basic recording information 521 is appropriately changed by the CPU 290.

The automatic timer-recording flag 522 is information indicating whether recording processing based on the basic recording information 521 is the automatic timer-recording processing. Specifically, “0” in the automatic timer-recording flag 522 indicates that the recording processing is the manual timer-recording processing and not the automatic timer-recording processing. Alternatively, “1” in the automatic timer-recording flag 522 indicates that the recording processing is the automatic timer-recording processing.

The memory 280 readably stores various types of information necessary when acquiring and storing desired contents information from the TS output from the communication unit 210, or reproducing the recorded contents information, as appropriate. Further, as described above, the memory 280 may be structured so as to include a drive or a driver for readably storing the various types of information in various recording media.

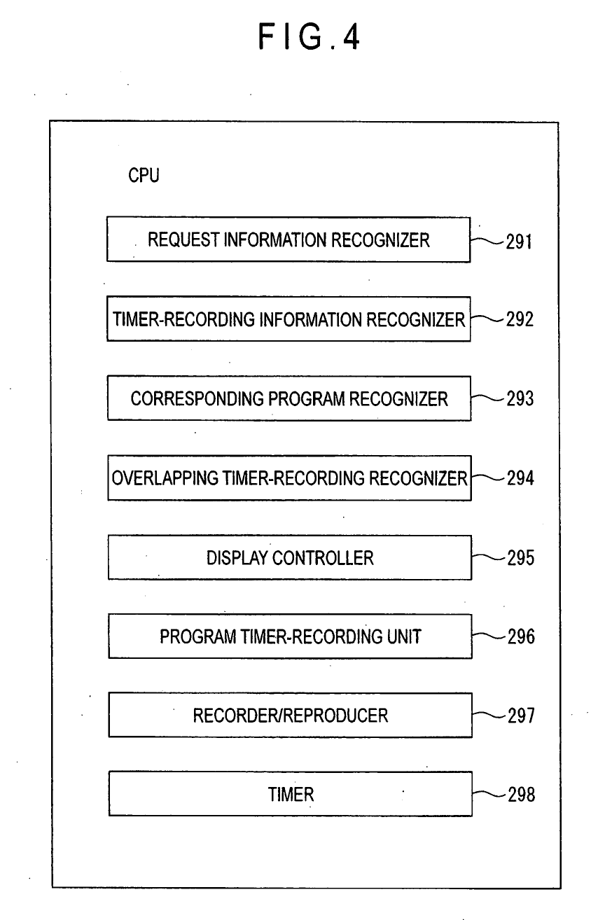

The CPU 290 is connected to the various components and controls an operation of each of the components. As shown in FIG. 4, for example, the CPU 290 includes as various programs a request information recognizer 291 which also functions as a selection unit and a distribution information selection unit, a timer-recording information recognizer 292, a corresponding program recognizer 293, an overlapping timer-recording recognizer 294 as a determination unit, a display controller 295 which also functions as a first display controller and a second display controller, a program timer recording unit 296 as a timer-recording controller, and a recording/reproducing section 297.

The request information recognizer 291 acquires request information set and input through a predetermined input operation in the input unit 260. The request information is information for requesting selection of one piece of timer-recording information 520 or the basic program information 430 from the pieces of timer-recording information 520 or the pieces of basic program information 430 displayed in a display area 321, information regarding a request for displaying the timer-recording list information 500 which is a list of programs scheduled to be recorded, information regarding a request for displaying the program list on a predetermined time and date, information regarding a request for recording a predetermined broadcast program, information regarding requesting the output unit 300 to output and reproduce a predetermined program, information regarding a request for deleting the contents information stored in the HDD 270, or the like.

The timer-recording information recognizer 292 recognizes the timer-recording list information 500 recorded on the HDD 270 when request information for displaying a screen for checking a program scheduled to be recorded is recognized by the request information recognizer 291. In addition, upon recognizing request information for selecting the timer-recording information 520 from the timer-recording list information 500 through the input operation of the user, the timer-recording information recognizer 292 recognizes the selected timer-recording information 520 and reads the basic recording information 521 in the timer-recording information 520. Further, the timer-recording information recognizer 292 readably stores the read basic recording information 521 in the memory 280 as appropriate.

The corresponding program recognizer 293 recognizes a program corresponding to the timer-recording information 520 from the program information table 400 based on the basic recording information 521 read by the timer-recording information recognizer 292. Specifically, the corresponding program recognizer 293 recognizes the basic recording information 521 of the timer-recording information 520 selected by the timer-recording information recognizer 292, and recognizes information on the recording start time and date, a recording end time and date, a channel number, and the like in the basic recording information 521. Then, the corresponding program recognizer 293 recognizes the channel information 420 that is the same as the channel number in the basic recording information 521, and the basic program information 430 containing the start-time information 432 that is substantially the same as the recording start time and date in the basic recording information 521. At this time, a broadcast time frame of the program recorded in the basic recording information 521, that is, a time from a program start time and date to a program end time and date do not need to necessarily match the time from the start-time information 432 to the end-time information 433 in the basic program information 430. In other words, the corresponding program recognizer 293 recognizes which broadcast time frame in the program information table 400 the broadcast time frame of the program recognized in the basic recording information 521 belongs to.

The overlapping timer-recording recognizer 294 recognizes the timer-recording information 520 whose broadcast time frame overlaps that of the selected timer-recording information 520 from the timer-recording list information 500 recognized by the timer-recording information recognizer 292. Here, the term “overlaps” refers to a case where the timer-recordings exceeding in number the recordable number of cases by which the recorder/reproducer 200 can record programs at the same time are set in the same time range. Specifically, the number of cases that are recordable at the same time refers to the number of cases by which the recorder/reproducer 200 can execute recording at the same time. For example, (1) the number of pieces of contents information that the communication unit 210 can acquire at the same time, (2) the number of tuners for receiving TV broadcast, (3) the number of pieces of contents information that can be written in the HDD 277 at the same time, or the like can be exemplified as a value thereof. However, in addition to those described above, the number of cases that are recordable at the same time widely refers to the number of cases that that can be subjected to the recording processing at the same time based on a capacity of the recorder/reproducer 200. The overlapping timer-recording recognizer 294 recognizes the program start time and date and the program end time and date of the selected timer-recording information 520. Then, the overlapping timer-recording recognizer 294 determines whether there is timer-recording information 520 whose recording start time and date and the recording end time and date have been set in the broadcast time frame between the program start time and date and the program end time and date of the selected timer-recording information 520. Further, determination is made on whether there is timer-recording information 520 containing the broadcast time frame between the program start time and date and the program end time and date of the selected timer-recording information 520, that, is, whether there is timer-recording information 520 whose program start time and date is set before the program start time and date of the selected timer-recording information 520 and whose program end time and date is set after the program end time and date of the selected timer-recording information 520.

After that, when it is judged that there is timer-recording information 520 whose recording start time and date or the recording end time and date is set within the broadcast time frame between the program start time and date and the program end time and date of the selected timer-recording information 520, or when it is judged that there is timer-recording information 520 containing the broadcast time frame between the program start time and date and the program end time and date of the selected timer-recording information 520, the overlapping timer-recording recognizer 294 recognizes the timer-recording information 520 as an overlapping timer-recording program overlapping the selected timer-recording information 520. In other words, in a case where the number of pieces of contents information that can be received by the communication unit 210 mounted to the recorder/reproducer 200 at the same time is “1”, when two programs overlapped in broadcast time are set for timer-recording, those two programs are in an overlapping state. Similarly, in a case where the number of pieces of contents information that can be received by the communication unit 210 at the same time is “2”, when three programs overlapped in broadcast time are set for timer-recording, the three programs are in the overlapping state.

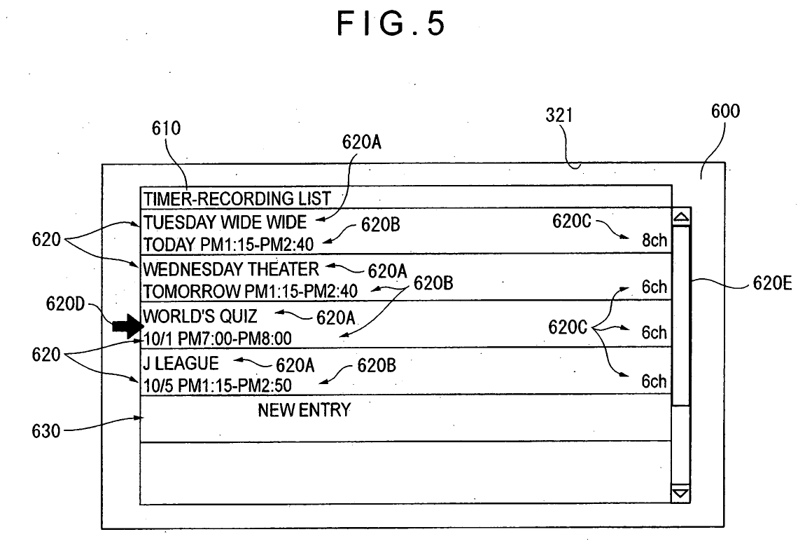

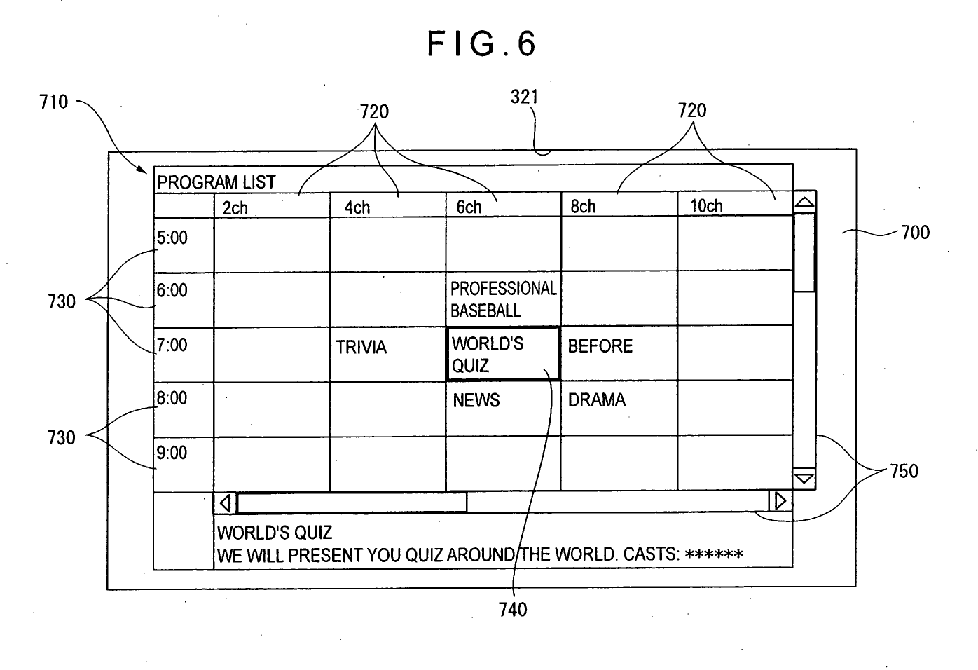

Upon recognizing the request information for displaying the timer-recording list information 500 by the request information recognizer 291, for example, the display controller 295 appropriately sets a display mode of a timer-recording list 600 as shown in FIG. 5 based on the timer-recording list information 500 recognized by the timer-recording information recognizer 292, and performs control to appropriately display the timer-recording list 600 in the display area 321 as a display unit of the display 320 of the output unit 300. Further, in a case where a signal indicating selection of predetermined timer-recording information 520 is recognized by the timer-recording information recognizer 292, or in a case where the request information for displaying a program list regarding the program broadcast schedule is recognized by the request information recognizer 291, the display controller 295 appropriately sets a program list 700 as shown in FIG. 6, and performs control to cause the program list 700 to be displayed in the display area 321.

In addition, in the timer-recording list 600, upon recognizing the signal indicating selection of the predetermined timer-recording information 520 through setting input of the user, the display controller 295 performs control to cause the program list 700 to be displayed so that the basic program information 430 recognized by the corresponding program recognizer 293 is arranged substantially at the center of the display area 321. In other words, the display controller 295 recognizes the broadcast time frame of the basic program information 430 based on the start-time information 432 and the end-time information 433 in the basic program information 430 recognized by the corresponding program recognizer 293, and sets and causes the program list 700 to be displayed so that the recognized broadcast time frame is arranged substantially at the center of the display area 321. Further, the display controller 295 sets and causes the program list 700 to be displayed so that the channel information 420 of the basic program information 430 recognized by the corresponding program recognizer 293 is arranged substantially at the center of the display area 321.

Further, upon recognizing the request information for carrying out the manual timer-recording processing of a program by the request information recognizer 291, for example, the display controller 295 causes a timer-recording setting screen (not shown) to be displayed. Note that the display controller 295 may be structured to carry out control of switching between not only the timer-recording list 600 and the program list 700, and the recording list screen 600 and the timer-recording setting screen, but also between the program list 700 and the timer-recording setting screen.

Here, a description will be given of the timer-recording list 600 which is displayed in the display area 321 by the display controller 295. As shown in FIG. 5, the timer-recording list 600 includes a timer-recording list display area 610.

The timer-recording list display area 610 is provided substantially at the center of the timer-recording list 600. The timer-recording list display area 610 includes a plurality of timer-recording display areas 620 obtained by dividing the timer-recording list display area 610 substantially equally in a vertical direction. In addition, the timer-recording information 520 of the timer-recording list information 500 is displayed in the timer-recording display areas 620. Specifically, title information 620A of a program corresponding to the timer-recording information 520, broadcast time frame information 620B based on the program start time and date and the program end time and date in the basic recording information 521 of the timer-recording information 520, and the like are displayed on the left-hand side of the timer-recording display areas 620. In addition, broadcast channel information 620C based on the channel number of the basic recording information 521 of the timer-recording information 520 is displayed on the right-hand side of the timer-recording display areas 620. Note that the title information 620A may be displayed in a case where the automatic timer-recording flag 522 of the timer-recording information 520 is “0”, for example, indicating that the recording processing is the automatic timer-recording processing by the CPU 290, and not displayed in a case where the timer-recording information 520 is timer-recording information 520 which has been set for timer-recording through the manual timer-recording processing.

Further, a selection cursor mark 620D for prompting selection of any one of the pieces of timer-recording information 520 displayed in the timer-recording list display area 610 is displayed on the left-hand side of one of the timer-recording display areas 620. In addition, a scrollbar 620E indicating whether there are more pieces of timer-recording information 520 in addition to those currently displayed is displayed on the right-hand side of the timer-recording list display area 610. Further, newly input information 630 indicating whether new timer-recording is to be added is displayed at the bottom of the timer-recording display area 620.

Next, a description will be given of a screen structure of the program list 700 displayed in the display area 321 by the control of the display controller 295. As shown in FIG. 6, the program list 700 includes a program list display area 710 and a program contents display area 760.

The pieces of basic program information 430 are displayed in the program list display area 710 in a tabular format. Specifically, the pieces of channel information 720 are displayed in a horizontal direction and the pieces of time information 730 are displayed in the vertical direction in the program list display area 710. In addition, the pieces of program information 410 corresponding to the program channel information 420 based on the respective channel numbers of the channel information 720 are displayed in association with the respective pieces of time information 730, for example, the pieces of title information 434 of the basic program information 430 are arranged in the vertical direction.

Further, at this time, basic program information 430 corresponding to selection timer-recording information, that is, timer-recording information 520 that has been selected with the selection cursor mark 620D in the timer-recording list 600 is displayed substantially at the center of the program list display area 710. At this time, in the program list display area 710, there are displayed pieces of basic program information 430 regarding programs that are broadcast within a predetermined time, for example, programs that are broadcast within two hours before and after the program that corresponds to the selection timer-recording information in the example of FIG. 6, with the basic program information 430 corresponding to the selection timer-recording information positioned at the center.

Further, in the program list display area 710, an area displaying the basic program information 430 corresponding to the timer-recording information 520 recorded in the timer-recording list information 500 and an area displaying other pieces of basic program information 430 are displayed in different background colors. In addition, in the program list display area 710, an area displaying the basic program information 430 corresponding to the overlapping timer-recording information and an area displaying the basic program information 430 corresponding to the other pieces of timer-recording information 520 are displayed in different background colors. Still further, in the program list display area 710, an area displaying the basic program information 430 corresponding to the selection timer-recording information and an area displaying the basic program information 430 corresponding to the overlapping timer-recording information are displayed in different background colors. Here, all the areas displaying the pieces of basic program information 430 of the programs corresponding to the overlapping timer-recording information may be displayed in different colors with respect to other areas, or only the area displaying the basic program information 430 of some programs may be changed in background color based on the order by which the timer-recordings have been set, or the like. For example, in a case where three programs of A, B, and C are recognized for the overlapping timer-recording, if the overlapping timer-recording can be eliminated by deleting only one setting of the timer-recording among the three timer-recordings, canceling of the last timer-recording can be prompted by differentiating the background color of only the area that displays the basic program information 430 of the program for which the timer-recording has been set last (e.g., program C), for example.

Further, a cursor 740 for selecting any one of the plurality of pieces of displayed basic program information 430 is displayed in the program list display area 710. Further, scrollbars 750 that indicate whether there are more pieces of basic program information 430 in addition to the currently displayed basic program information 430 are respectively displayed on the lower side and the right-hand side of the program list display area 710.

The program contents display area 760 contains a description of detailed contents of the basic program information 430 selected with the cursor 740. In other words, the start-time information 432, the end-time information 433, the title information 434, the subtitle information 435, the genre information 436, the description information 437, and the like of the basic program information 430 are displayed in the program contents display area 760.

The program timer-recording unit 296 records the timer-recording information 520 recognized through setting input of the user in the timer-recording list information 500. Further, the program timer-recording unit 296 records the timer-recording information 520 set through the automatic timer-recording processing by the CPU 290 in the timer-recording list information 500. Specifically, the program timer-recording unit 296 recognizes at least the channel number, the program start time and date, and the program end time and date of the program to be recorded, to thereby produce the basic recording information 521. Then, the program timer-recording unit 296 determines whether the timer-recording processing has been carried out through the setting input of the user, or whether the timer-recording processing has been carried out through the automatic timer-recording processing by the CPU, and sets the automatic recording flag. After that, the program timer-recording unit 296 adds the automatic recording flag to the generated basic recording information 521, generates timer-recording information 520, and records the generated timer-recording information 520 in the timer-recording list information 500.

The recording/reproducing section 297 controls the operation of the communication unit 210, the Demux 220, the recording/reproducing processor 250, and the like, and carries out processing of receiving contents information of a desired TV broadcast program and readably storing the contents information in the HDD 270 as appropriate. Specifically, the recording/reproducing section 297 carries out processing of storing contents information that is currently received and reproduced by the operation signal based on the input operation made in the input unit 260, or processing of receiving and storing, based on the timer-recording information, contents information when the current time timed with a timer 298 matches the recording start time and date in the timer-recording information.

Further, the recording/reproducing section 297 controls the operation of the Demux 220, the decoder 230, the recording/reproducing processor 250, and the like, and carries out processing of outputting the contents information of the desired TV broadcast program to the output unit 300 to cause the output unit 300 to reproduce the contents information. Specifically, the recording/reproducing section 297 reads out from the HDD 270, according to the operation signal based on the input operation made in the input unit 260, contents information specified through the input operation or the like for selecting thumbnails that are displayed in a form of a list on the output unit 300, or contents information that is requested in advance to be reproduced within a predetermined time, such as through so-called timer reproduction. After that, the recording/reproducing section 297 appropriately processes the contents information in the decoder 230 and outputs the contents information to the output unit 300.

The timer 298 times the current time and date based on a reference pulse such as an internal clock, for example. Further, the timer 298 appropriately outputs current time and date information regarding the timed current time and date.

(Operation of Recording/Reproducing System)

Next, an operation of the recording/reproducing system 100 will be described with reference to the drawings.

(Screen Switching Processing)

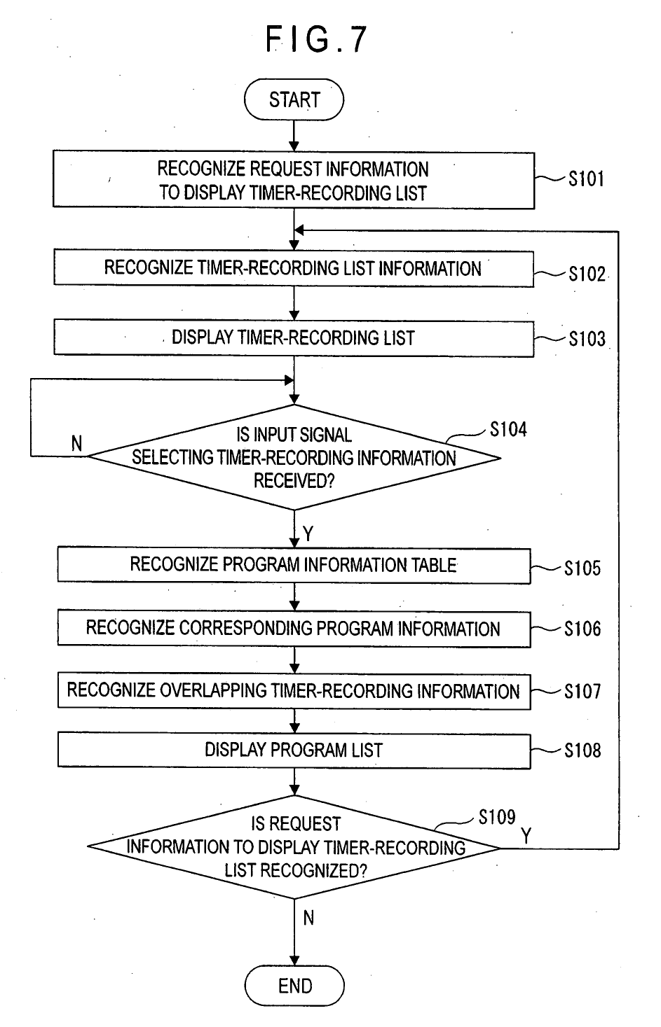

Screen switching processing of the recording/reproducing system 100 will be described based on FIG. 7. In FIG. 7, the CPU 290 in the recorder/reproducer 200 of the recording/reproducing system 100 causes the request information recognizer 291 to recognize the request information that has been set and input through the input operation of the user. Then, the request information recognizer 291 recognizes presence or absence of request information for displaying the timer-recording list 600 in the display area 321 based on the set and input request information (Step S101). After that, when it is judged by the request information recognizer 291 in Step S101 that there is request information for displaying the timer-recording list 600, the timer-recording information recognizer 292 of the CPU 290 recognizes the timer-recording list information 500 recorded on the HDD 270 (Step S102).

After that, the display controller 295 of the CPU 290 sets the timer-recording list 600 as shown in FIG. 5 based on the timer-recording list information 500 recognized in Step S102, and performs control to cause the timer-recording list 600 to be displayed in the display area 321 of the display 320 of the output unit 300 (Step S103).

Next, the CPU 290 determines whether one piece of timer-recording information 520 has been selected from the timer-recording list 600 displayed in Step S103 based on the setting input made through the input operation of the user. Then, upon recognizing that the timer-recording information 520 has been selected (Step S104), the timer-recording information recognizer 292 of the CPU 290 readably stores the timer-recording information 520 in the memory 280 as selection timer-recording information as appropriate.

When it is determined in Step S104 that the selection timer-recording information has been selected by the timer-recording information recognizer 292, the CPU 290 reads the channel number, the program start time and date, the program end time and date, and the like recorded in the basic recording information 521 of the selection timer-recording information. Then, the corresponding program recognizer 293 of the CPU 290 recognizes the program information 410 of the day on which the selection timer-recording information is to be broadcast from the program information table 400. In addition, the corresponding program recognizer 293 recognizes the basic program information corresponding to the timer-recording information 520 (Step S106).

Next, the overlapping timer-recording recognizer 294 of the CPU 290 recognizes the timer-recording information 520 that overlaps the selection timer-recording information. In other words, the overlapping timer-recording recognizer 294 of the CPU 290 computes the broadcast time frame between the program start time and date and the program end time and date of the selection timer-recording information. Then, the overlapping timer-recording recognizer 294 recognizes the timer-recording information 520 containing the broadcast time frame that overlaps the computed broadcast time frame. In other words, the overlapping timer-recording recognizer 294 recognizes the timer-recording information 520 whose program start time and date and the program end time and date are included in the computed broadcast time frame, or the timer-recording information 520 whose program start time and date is before the program start time and date of the selection timer-recording information and whose program end time and date is after the program end time and date of the selection timer-recording information (Step S107).

After that, the display controller 295 of the CPU 290 carries out control to switch the timer-recording list 600 displayed in the display area 321 of the display 320 of the output unit 300 to the program list 700, and to display the program list 700 (Step S108).

At this time, the display controller 295 arranges the broadcast time frame of the basic program information 430 and the channel information 420 which correspond to the selection timer-recording information substantially at the center, arranges in the program list display area 710 the basic program information 430 of the program that is to be broadcast within a predetermined time before and after the selection timer-recording information, for example, the program that is to be broadcast within two hours before and after the selection timer-recording information, and sets the program list 700. Further, the display controller 295 carries out control so that the area displaying the basic program information 430 corresponding to the timer-recording information 520 recorded in the timer-recording list information 500 and the area displaying other pieces of basic program information 430 are displayed in different background colors. In addition, the display controller 295 carries out control so that the area displaying the basic program information 430 corresponding to the overlapping timer-recording information recognized in Step S107 and the area displaying the basic program information 430 corresponding to other pieces of timer-recording information 520 are displayed in different background colors. Further, the display controller 295 carries out control so that the area displaying the basic program information 430 corresponding to the selection timer-recording information and the area displaying the basic program information 430 corresponding to the overlapping timer-recording information are displayed in different background colors.

Subsequently, the CPU 290 determines whether the request information for re-displaying the timer-recording list 600 has been input through the input operation of the user (Step S109). Then, in a case where the request information for displaying the timer-recording list is recognized, the CPU 290 returns to Step S102 and recognizes the timer-recording list information 500 by the timer-recording information recognizer 292.

(Operational Effect of Recording/Reproducing System)

As described above, the thus structured recording/reproducing system 100 performs control to generate a program information table 400 based on the distributed EPG data, and to display the timer-recording information 520 recorded in the timer-recording list information 500 in the display area 321 as the timer-recording list 600. Then, upon recognizing that at least one piece of timer-recording information 520 has been selected among the pieces of displayed timer-recording information 520, control is carried out to display the program list 700 which is a program list containing the basic program information 430 corresponding to the selected timer-recording information 520. Accordingly, the user can easily check the program that has been set for timer-recording based on the program list. In addition, by displaying the timer-recording information 520 on the program list, it is possible to easily check the programs that are broadcast before and after the program that corresponds to the timer-recording information 520, and to easily check whether there is timer-recording information 520 that overlaps the selected timer-recording information 520.

Further, the corresponding program recognizer 293 recognizes the program start time and date, the program end time and date, and the channel number of the selection timer-recording information, that is, timer-recording information 520 selected through the input operation of the user. After that, the corresponding program recognizer 293 recognizes which broadcast time frame in the program information table 400 the broadcast time frame of the program corresponding to the selection timer-recording information belongs to. Then, the display controller 295 causes the broadcast time frame of the program corresponding to the selection timer-recording information to be displayed substantially at the center of the program list display area. Thus, the user can easily check in which broadcast time frame in the program list the selection timer-recording program is to be broadcast.

Further, with the basic program information 430 corresponding to the selection timer-recording information at the center, the display controller 295 causes the basic program information 430 regarding the programs that are broadcast within a predetermined time, for example, programs that are broadcast within two hours before and after the selected program to be displayed. Accordingly, the user can specifically and easily check the programs that are broadcast before and after the program corresponding to the selection timer-recording information, and the programs that are broadcast in substantially the same broadcast time frame. Further, by arranging the basic program information 430 corresponding to the selection timer-recording information substantially at the center of the program list display area as described above, the channel number of the selection timer-recording information is displayed substantially at the center of the program list display area. Thus, by arranging the program corresponding to the selection timer-recording information substantially at the center, it is possible to display the basic program information 430 regarding the programs whose broadcast time frame is substantially the same as that of the selection timer-recording information above and below and on both sides of the program. Therefore, the user can easily check the programs that are broadcast in substantially the same time frame as the program corresponding to the selection timer-recording information, or programs corresponding to the overlapping timer-recording information.

Further, the display controller 295 displays in the program list display area 710 the area displaying the basic program information 430 corresponding to the selection timer-recording information and the area displaying the other pieces of basic program information 430 in different background colors. Accordingly, it is possible to easily recognize the area in which the basic program information 430 corresponding to the selection timer-recording information is displayed in the program list display area 710.

Further, the display controller 295 displays in the program list display area the area displaying the basic program information 430 corresponding to the selection timer-recording information, the area displaying the basic program information 430 corresponding to the overlapping timer-recording information, the area displaying the basic program information 430 corresponding to other pieces of timer-recording information 520, and the area displaying other pieces of basic program information 430 in different background colors. Thus, the basic program information 430 corresponding to the selection timer-recording information, the basic program information 430 corresponding to the overlapping timer-recording information, the basic program information 430 corresponding to other pieces of timer-recording information 520, and other pieces of basic program information 430 can be easily recognized by the difference in background colors. Therefore, the user can easily check the programs that are broadcast before and after the program corresponding to the selection timer-recording information, presence or absence of the overlapping timer-recording information, and the like.

### OTHER EMBODIMENTS

Note that the present invention is not limited to the embodiment described above, and includes modifications shown below in a range that the object of the present invention can be achieved.

Specifically, as information to be distributed, there can be applied various types of data such as music, videos, software, and games to be distributed in addition to the TV broadcast programs and radio broadcast programs distributed from broadcast stations.

In addition, in the above embodiment, control for recognizing the timer-recording information 520 recorded in the timer-recording list information 500 and displaying the program list 700 with the basic program information 430 corresponding to the timer-recording information 520 as the center has been performed. However, the present invention is not limited thereto. For example, contents information regarding contents of the program that has already been recorded may be recognized, and the display controller 295 may carry out control so as to display on the program list 700 a program list of a broadcast date of the contents information selected in the program list. In this case, it is only necessary that the EPG data acquired in the past is accumulated, or the program information table 400 is recorded simultaneously with recording a program. With such structure, it is possible to check a content of the contents recorded in the past in the program contents display area 760 of the program list 700, for example.

In addition, when controlling to display the program list 700 in Step S108, the display controller 295 carries out control to display the area displaying the basic program information 430 corresponding to selection program information, the area displaying the basic program information 430 corresponding to the overlapping program, the area displaying the basic program information 430 corresponding to other pieces of timer-recording information 520, and the area displaying other pieces of basic program information 430 in different background colors. However, the present invention is not limited thereto. For example, information in the program list 700 may be displayed with different display character colors, different fonts, or different character sizes. In addition, the display mode may be changed to discriminate the areas from one another.

Further, there may be employed a structure capable of carrying out the timer-recording processing of a program by selecting the area displaying the basic program information 430 through the input unit such as a remote controller in the program list 700. In this case, the timer-recording processing can be carried out directly from the program list 700. With such structure, checking of the timer-recording and registration of new timer-recording information can easily be carried out on the same screen.

In addition, the program timer-recording unit 296 of the CPU 290 may produce timer-recording information 520 based on the start-time information 432, the end-time information 433, and the channel information 420 of the basic program information 430 selected with the cursor 740 in the program list 700. In this case, the display controller 295 may perform control to switch the display from the program list 700 to the timer-recording list 600, and display the timer-recording information 520 produced by the program timer-recording unit 296.

Further, upon recognizing that the new input information 630 has been selected in the timer-recording list 600, for example, the program timer-recording unit 296 of the CPU 290 may cause the display controller 295 to switch the display from the timer-recording list 600 to the program list 700. In this case, the user can timer-record the program by selecting the basic program information 430 displayed on the program list 700.

In addition, control has been carried out by the display controller 295 to display in the program list display area 710 the programs that are broadcast within a predetermined time before and after the program corresponding to the selection timer-recording information. However, the present invention is not limited thereto. In other words, the display controller 295 may control to display programs of one whole day in the program list display area 710, for example. Further, the number of programs to be displayed in the program list display area 710 may be determined by the setting input of the user. With such structure, the display controller 295 can set a program list 700 with which the user can most easily check the basic program information 430.

Further, in the above embodiment, the program information table 400 has been produced by receiving the EPG data by the communication unit 210. However, the present invention is not limited thereto. For example, the program information 410 stored in the program information table 400 may be received directly. In addition, the EPG data or the program information 410 may be received via a network such as the Internet, or the program information 410 may be acquired via other recording media.

### EFFECT OF EMBODIMENTS

As described above, the thus structured recording/reproducing system 100 produces the program information table 400 based on the distributed EPG data, and controls to display the timer-recording information 520 recorded in the timer-recording list information 500 in the display area 321 as the timer-recording list 600. In addition, upon recognizing that at least one piece of the timer-recording information 520 has been selected among the pieces of displayed timer-recording information 520, the recording/reproducing system 100 controls to display the program list 700 which is a program list containing the basic program information 430 corresponding to the timer-recording information 520 based on the program information table 400. Thus, the user can easily check the presence or absence of the timer-recording information of the programs that overlap the program set for timer-recording, and check the programs that are broadcast before and after the program set for timer-recording.

### INDUSTRIAL APPLICABILITY

The present invention can be applied to an information processing device, an information processing method, an information processing program, and a recording medium recorded with the information processing program, for processing information.

1-13. (canceled)

14. An information processing device, comprising:
a distribution information acquisition unit for acquiring distribution information regarding distribution of contents;
a producing unit for producing a contents distribution list based on the distribution information;
a timer-recording controller for programming timer-recording of the contents;
a first display controller for controlling a display unit to display a list of timer-recording information regarding timer-recording of the contents including distribution time and date information of the contents;
a selection unit for selecting at least one of the timer-recording information in the list displayed on the display unit; and
a second display controller for controlling the display unit to display the contents distribution list containing information on contents corresponding to the selected timer-recording information with the distribution time and date of the selected timer-recording information being disposed substantially at the center of the display unit.

15. An information processing device according to claim 14, wherein the second display controller controls the display unit to display, based on the distribution time and date of the distribution time and date information, the contents distribution list which includes distribution time and date within a predetermined time from the distribution time and date of the selected timer-recording information.

16. An information processing device according to claim 14, wherein:
the timer-recording information contains frequency information regarding a distribution frequency of the information; and
the second display controller controls the display unit to display, based on a frequency of the frequency information, the contents distribution list such that a distribution frequency of the selected timer-recording information is displayed substantially at the center of the display unit.

17. An information processing device according to claim 14, wherein the second display controller displays the distribution information corresponding to the timer-recording information in a display mode different from that of other distribution information in the contents distribution list.

18. An information processing device according to claim 17, further comprising a determination unit for determining whether distribution information corresponding to two or more of the timer-recording information is displayed on the display unit,
wherein the second display controller displays the distribution information corresponding to the timer-recording information selected by the selection unit in the display mode different from that of the distribution information corresponding to the other timer-recording information when the determination unit has determined that the distribution information corresponding to two or more of the timer-recording information is displayed.

19. An information processing device according to claim 18, wherein:
the determination unit determines that, when the number of pieces of the timer-recording information overlapping in distribution time exceeds the number of recordable cases which is the number of the contents that can be recorded at the same time, the timer-recording information are overlapping timer-recording information; and
when the determination unit has determined that the timer-recording information are the overlapping timer-recording information, the second display controller displays the distribution information corresponding to the timer-recording information substantially overlapping in distribution time and date in a display mode different from that of the distribution information corresponding to the selected timer-recording information and the distribution information corresponding to the other timer-recording information.

20. An information processing device according to claim 14, further comprising a distribution information selection unit for selecting at least one distribution information from among the distribution information corresponding to the timer-recording information displayed on the display unit by the second display controller,
wherein the first display controller controls the display unit to display the timer-recording information corresponding to the selected distribution information.

21. An information processing device according to claim 14, further comprising a distribution information selection unit for selecting at least one distribution information from among the distribution information displayed on the display unit by the second display controller,
wherein the timer-recording controller timer-records contents corresponding to the selected distribution information.

22. An information processing method, comprising:
acquiring distribution information regarding distribution of contents;
producing a contents distribution list based on the distribution information;
programming timer-recording of the contents;
controlling a display unit to display a list of timer-recording information regarding timer-recording of the contents including distribution time and date information of the contents;
selecting at least one of the timer-recording information in the list displayed on the display unit; and
controlling the display unit to display the contents distribution list containing the contents corresponding to the selected timer-recording information with the distribution time and date of the selected timer-recording information being disposed substantially at the center of the display unit.

23. An information processing program stored in a recording medium in a manner readable by a computing unit, the information-processing program causing the computing unit to function as the information processing device according to claim 14.

24. An information processing program stored in a recording medium in a manner readable by a computing unit, the program causing the computing unit to carry out the information processing method according to claim 22.

25. A recording medium recorded with an information processing program, which stores the processing program according to claim 23 in a computer-readable manner.

26. A recording medium recorded with an information processing program, which stores the processing program according to claim 24 in a computer-readable manner.
